(19) United States
(12) Patent Application Publication
(10) Pub. No.: US 2024/0132809 A1
(43) Pub. Date: Apr. 25, 2024

(54) LIQUID LAUNDRY COMPOSITION

(71) Applicant: RECKITT BENCKISER VANISH B.V., Hoofddorp (NL)

(72) Inventors: Anna MARCHIANI, Mira (IT); Enrico GIUSTO, Mira (IT); Valeria BALDAN, Mira (IT)

(21) Appl. No.: 18/546,291

(22) PCT Filed: Feb. 17, 2022
(86) PCT No.: PCT/EP2022/053893

§ 371 Date: Aug. 13, 2023

(30) Foreign Application Priority Data
Feb. 19, 2021 (GB) 2102327.0

(51) Int. Cl. C11D 3/395; C11D 3/37; C11D 3/39; C11D 17/00

(52) U.S. Cl. CPC C11D 3/3951; C11D 3/3773; C11D 3/3776; C11D 3/3942; C11D 17/0008; C11D 2111/12

(57) ABSTRACT

The present invention relates to a liquid laundry composition comprising: between 1 wt. % and 15 wt. % of an oxygen-based bleach, based on the total weight of the composition; between 0.001 wt. % and 10 wt. % of a homopolymer of 1-vinyl-2-pyrrolidone (PVP), based on the total weight of the composition; wherein the weight ratio of the homopolymer of 1-vinyl-2-pyrrolidone to the oxygen-based bleach is higher than 0.009:1. It also relates to a method of washing a garment using the laundry composition and to the use of the laundry composition for the removal of stains from a garment, and preferably dye transfer reduction or inhibition from a garment.

The present invention relates to a liquid laundry composition, to a method of washing a garment using the laundry composition, and to the use of the composition for the removal of stains from a garment, in particular stains comprising a polyphenolic compound.

### BACKGROUND

Consumers associate desirability and wearability of a garment with characteristics such as e.g., absence of stains or absence or reduction of colour fading. It is preferred when both characteristics are achieved in a simple way.

The removal of stains is achieved using bleaching agents, surfactants and/or enzymes. For example, enzymatic stains require enzymes, oil-based stains require enzymes or a combination of surfactants, bleachable stains require a bleaching agent to remove them.

Although, bleachable stains may be removed with bleaching agents, this often leads to discoloration or dye transfer from a garment. Therefore, it is not an easy task to remove bleachable stains whilst inhibiting colour fading or dye transfer.

In addition, some stains contain polyphenols, which are naturally occurring compounds having multiples of phenol units. Examples of polyphenol-containing foods are tea, red wine, curry, and chocolate. Some of these compounds have been used as dyes and for tanning garments; which gives an idea that it is complicated to remove stains of polyphenolic compound soils from a garment.

Curcumin is a yellow active ingredient in turmeric spice; it is a hydrophobic polyphenol derived from the rhizome of turmeric (Curcuma longa). Foods prepared with blends of spices containing turmeric or curry lead to stains that are impossible to remove with common laundry detergents, chlorine bleaches, existing laundry additives or any home remedies. Turmeric is a strong natural colourant and the additional presence of oil, fat, meat and other protein components like egg and milk make this type of stains even more complicated to clean. This means that in cuisines where curry/turmeric plays an important role, people are left with no solution and they have no choice than to cope with curry/turmeric stains residues on their garments, even after washing.

For the removal of stains containing polyphenols, bleaching agents, preferably in combination with enzymes, are normally used. Again, this often leads to discolouration or dye transfer from a garment.

To avoid discolouration or dye transfer from a garment, dye transfer inhibitors are commonly used. The activity of dye transfer inhibitors can be reduced by traditional bleaching agents, such as hydrogen peroxide, peroxide compounds and/or peroxyacids. Some solutions have been proposed to achieve stain removal of compositions comprising dye transfer inhibitors. EP1268731 describes bleaching compositions based on atmospheric oxygen, without hydrogen peroxide or a source of hydrogen peroxide, comprising a ligand which forms a complex with a transition metal. EP0964910 describes compositions comprising a xylan degrading enzyme. EP0907703 describes compositions comprising modified polyamines to provide dye transfer inhibition in the presence of bleaching agents.

Therefore, there is a need of a laundry composition capable of removing stains, in particular those comprising a polyphenolic compound, such as turmeric and/or curry stains, whilst reducing or inhibiting dye transfer from a garment. Preferably the laundry composition should comprise traditional bleaching agents, such as hydrogen peroxide.

It is an object of the present invention to provide a laundry composition that provides a solution for this need.

To this end, the present disclosure provides a liquid laundry composition comprising an oxygen-based bleach, a homopolymer of 1-vinyl-2-pyrrolidone, wherein the weight ratio of the homopolymer of 1-vinyl-2-pyrrolidone to the oxygen-based bleach is higher than 0.009:1.

### SUMMARY OF THE INVENTION

In a first aspect, the present invention relates to a liquid laundry composition comprising:
between 1 wt. % and 15 wt. % of an oxygen-based bleach, based on the total weight of the composition;
between 0.001 wt. % and 10 wt. % of a homopolymer of 1-vinyl-2-pyrrolidone (PVP), based on the total weight of the composition;
wherein the weight ratio of the homopolymer of 1-vinyl-2-pyrrolidone to the oxygen-based bleach is higher than 0.009:1.

In one embodiment, the weight ratio of the homopolymer of 1-vinyl-2-pyrrolidone to the oxygen-based bleach is lower than 10:1, preferably lower than 5:1, more preferably lower than 1:1, even more preferably between 0.01:1 and 0.5:1.

In another embodiment, the oxygen-based bleach is hydrogen peroxide or a precursor of hydrogen peroxide, preferably the oxygen-based bleach is hydrogen peroxide.

The composition may comprise between 1 wt. % and 13 wt. % of oxygen-based bleach, based on the total weight of the formulation, preferably between 2 wt. % and 13 wt. %, more preferably between 3 wt. % and 13 wt. %, even more preferably between 4 wt. % and 12 wt. %.

In one embodiment, the homopolymer of 1-vinyl-2-pyrrolidone (PVP) has a molecular weight of between 10 000 g/mol and 200 000 g/mol, preferably between 20 000 g/mol and 100 000 g/mol, more preferably between 30 000 g/mol and 50 000 g/mol, even more preferably between 35 000 g/mol and 45 000 g/mol.

The composition may comprise between 0.005 wt. % and 5 wt. % of the homopolymer of 1-vinyl-2-pyrrolidone (PVP), based on the total weight of the composition, preferably between 0.01 wt. % and 2.5 wt. %, more preferably between 0.025 wt. % and 1 wt. %, even more preferably between 0.05 wt. % and 0.5 wt. %.

The composition may further comprise between 0.5 wt. % and 70 wt. % of one or more surfactants, based on the total weight of the composition, preferably between 1 wt. % and 35 wt. %, more preferably between 5 wt. % and 25 wt. %, even more preferably between 10 wt. % and 20 wt. %.

In one embodiment the one or more surfactants are selected from the group consisting of anionic surfactants, non-ionic surfactants, cationic surfactants, amphoteric surfactants, zwitterionic surfactants, and combinations thereof; preferably the one or more surfactants are selected from the group consisting of non-ionic surfactants, anionic surfactants and combinations thereof.

The composition may comprise between 10 wt. % and 90 wt. % of water, based on the total weight of the composition, preferably between 20 wt. % and 85 wt. %, more preferably between 50 wt. % and 80 wt. %.

In one preferred embodiment, the pH at 20° C. of the composition is between 2.5 and 6.5, preferably between 3 and 6, more preferably between 4 and 5.

In one embodiment, the composition has a viscosity measured at 20° C. and 10 rpm of between 50 mPa·s and 50 000 mPa·s, preferably between 100 mPa·s and 10 000 mPa·s, more preferably between 250 mPa·s and 5 000 mPa·s, even more preferably between 500 mPa·s and 2500 mPa·s.

In a preferred embodiment, the composition is a laundry additive composition.

In a second aspect, the invention relates to a method of washing a garment, comprising:
washing a garment with the laundry composition according to the first aspect of the invention; or
washing a garment with a mixture comprising a laundry detergent composition and the laundry composition according to the first aspect of the invention; or
adding a laundry composition according to the first aspect of the invention to a bucket with water and soaking for a predetermined length of time; or
   a) pre-treating the garment with the laundry composition according to the first aspect of the invention; and
   b) washing the pre-treated garment of step a) with the laundry composition according to the first aspect of the invention, or a laundry detergent composition, or with a mixture comprising a laundry detergent composition and the laundry composition according to the first aspect of the invention.

In a third aspect, the invention relates to a use of the laundry composition according to the first aspect of the invention for the removal of stains from a garment, and preferably for the reduction or inhibition of dye transfer from a garment

In one embodiment, the stains comprise a polyphenolic compound, preferably wherein the stains comprise turmeric and/or curry stains.

### Definitions

The following definitions are used in the present application.

“Laundry composition” as used in the present application means: compositions which can be used for pre-treating a garment before washing the garment with a laundry detergent, and/or that can be used alone for washing a garment, and/or that can be used together with the laundry detergent during washing of the garment, and/or that can be used as a rinse cycle composition. In other words, the laundry composition can be used alone for washing a garment or can be used as an auxiliary of the laundry detergent. A laundry composition includes, but is not limited to, products for the care of garments, removal of stains, cleaning of garments, sanitisation of garments, disinfecting of garments, stain removers.

“Laundry additive composition” as used in the present application means: composition which is used for providing a specific consumer benefit, such as: removal of stains, reduction or inhibition of dye transfer, elimination of malodour, improvement of whiteness and/or disinfection of garments. This means that the mean action of a laundry additive is not the removal or grim and dirt. Furthermore, a laundry additive is commonly used as a pre-treatment, in soaking conditions or together with a laundry detergent composition.

### DETAILED DESCRIPTION OF THE INVENTION

In a first aspect, the present invention relates to a liquid laundry composition comprising:
between 1 wt. % and 15 wt. % of an oxygen-based bleach, based on the total weight of the composition;
between 0.001 wt. % and 10 wt. % of a homopolymer of 1-vinyl-2-pyrrolidone (PVP), based on the total weight of the composition;
wherein the weight ratio of the homopolymer of 1-vinyl-2-pyrrolidone to the oxygen-based bleach (PVP:oxygen-based bleach) is higher than 0.009:1.

The present inventors have surprisingly observed a synergistic effect between a homopolymer of 1-vinyl-2-pyrrolidone (PVP) and an oxygen-based bleach above certain weight ratio between the components, i.e. above a weight ratio PVP:oxygen-bleach ratio of 0.009:1. This synergy is shown by the stain removal properties of the composition according to the invention.

By a weight ratio of the PVP to the oxygen-based bleach higher than 0.009:1 is meant that it can be .e.g. 0.0095:1, 0.001:1, 0.0015:1, etc.

The composition according to the invention provides, in particular, removal of stains comprising polyphenolic compounds such as turmeric, red wine, chocolate. This is surprising as, stain removal of, for example, chocolate and/or curry stains, would be expected by adding enzymes or dramatically increasing the bleach content of the composition, but not by adjusting the ratio of PVP and oxygen-based bleach.

The person skilled in the art will recognise that PVP is normally used as a dye transfer inhibitor; however, it is surprising that it has a synergy with the oxygen-based bleach as shown in the present disclosure.

Without wishing to be bound by any theory, the present inventors believe that the PVP in the composition not only aids with the dye transfer inhibition, but also helps solubilising polyphenolic compounds, such as turmeric, which leads to the combined effect of dye transfer reduction or inhibition and removal of stains.

The weight ratio of the homopolymer of 1-vinyl-2-pyrrolidone to the oxygen-based bleach may be lower than 10:1, preferably lower than 5:1, more preferably lower than 1:1, even more Preferably Between 0.001:1 and 0.5:1

Oxygen-Based Bleach

The oxygen-based bleach may be hydrogen peroxide or a precursor of hydrogen peroxide, preferably the oxygen-based bleach is hydrogen peroxide.

Due to the lack of stability of liquid peroxide, because of its high reactivity, in combination with other detergent ingredients, oxygen bleach precursors are commonly used in the detergent industry. These are broken down in situ to release hydrogen peroxide.

The most common bleach precursor is sodium percarbonate. This is solid and, if kept dry, fairly stable allowing it to be mixed with a wide variety of common detergent composition components. The majority of detergents using oxygen bleach cleaning utilise sodium percarbonate as a source of oxygen bleach.

Despite its effectiveness, sodium percarbonate still has drawbacks. The percarbonate needs to break down to release the peroxide and this is a highly temperature-dependent reaction. With household energy use (due to a desire to limit damage to the environment) being an increasingly important concern, reduced washing temperatures are offered on all new domestic cleaning machines. Where once 60° C. washing was standard, now 30-40° C. cleaning temperatures are encouraged. The reduced temperatures make the breakdown of the percarbonate happen much more slowly, reducing the effectiveness of the bleaching. Catalysts can be added to the detergent compositions to assist this process at lower temperatures, but they are an additional cost and waste.

Therefore, the specially preferred oxygen-based bleach is hydrogen peroxide.

The composition may comprise between 1 wt. % and 13 wt. % of oxygen-based bleach, based on the total weight of the formulation, preferably between 2 wt. % and 13 wt. %, more preferably between 3 wt. % and 13 wt. %, even more preferably between 4 wt. % and 12 wt. %.

PVP and Dye Transfer Inhibitors

In an embodiment, the homopolymer of 1-vinyl-2-pyrrolidone (PVP) has a molecular weight of between 10 000 g/mol and 200 000 g/mol, preferably between 20 000 g/mol and 100 000 g/mol, more preferably between 30 000 g/mol and 50 000 g/mol, even more preferably between 35 000 g/mol and 45 000 g/mol. A preferred example of PVP is Sokalan HP53 ex. BASF, which is a suspension with approximately 30% of a PVP having a molecular weight of about 40 000 g/mol.

As used herein the term molecular weight refers to the weight average molecular weight.

The composition may comprise between 0.005 wt. % and 5 wt. % of the homopolymer of 1-vinyl-2-pyrrolidone (PVP), based on the total weight of the composition, preferably between 0.01 wt. % and 2.5 wt. %, more preferably between 0.025 wt. % and 1 wt. %, even more preferably between 0.05 wt. % and 0.5 wt. %.

The composition may further comprise one or more dye transfer inhibitors selected from the group comprising polyvinylalcohol, fatty amides, sodium carboxylmethyl cellulose, hydroxypropyl methyl cellulose, polyvinylimidazole, polyvinyloxazolidone, polyamine N-oxide polymers, copolymers of 1-vinyl-2-pyrrolidone and 1-vinylimidazole (PVP-VI), and combinations thereof.

Surfactants

The composition may comprise one or more surfactants. The one or more surfactants may be selected from the group consisting of anionic surfactants, non-ionic surfactants, cationic surfactants, amphoteric surfactants, zwitterionic surfactants, and combinations thereof; preferably the one or more surfactants are selected from the group consisting of non-ionic surfactants, anionic surfactants and combinations thereof. Many such suitable surfactants are described in Kirk Othmer's Encyclopedia of Chemical Technology, 3rd Ed., Vol. 22, pp. 360-379, “Surfactants and Detersive Systems”.

The composition may comprise between 0.5 wt. % and 70 wt. % of one or more surfactants, based on the total weight of the composition, preferably between 1 wt. % and 35 wt. %, more preferably between 5 wt. % and 25 wt. %, even more preferably between 10 wt. % and 20 wt. %.

For example, the surfactant may comprise one or more non-ionic surfactants, preferably ethoxylated alcohols and ethoxylated alkyl phenols having the formula R¹(OCH₂CH₂)ₙOH; wherein R 1 is an aliphatic hydrocarbon radicals containing between 10 and 24 carbon atoms or alkyl phenyl radicals in which the alkyl groups contain from 10 to 22 carbon atoms; and n has an average value of from 1 to 10.

The surfactant may comprise any conventional anionic surfactant or a mixture of them used in detergent products. These include, for example, the alkyl benzene sulfonic acids and their salts as well as alkoxylated or non-alkoxylated alkyl sulfate materials. The anionic surfactants may be present in acid form or in neutralized (e.g., salt) form. The anionic surfactants may be linear, branched, or a mixture thereof. An example of an anionic surfactant is sodium cumenesulphonate.

Examples of anionic surfactants are the alkali metal salts of C₁₀₋₁₆ alkyl benzene sulphonic acids or C₁₁₋₁₄ alkyl benzene sulphonic acids.

Another exemplary type of anionic surfactant is alkoxylated alkyl sulphate surfactants, such as ethoxylated alkyl sulphate surfactants. Such materials are also known as alkyl ether sulphates or alkyl polyethoxylate sulphates.

Alkyl ether sulphates are generally available in the form of mixtures comprising varying R′ chain lengths and varying degrees of ethoxylation. Frequently such mixtures also contain some non-ethoxylated alkyl sulphate (“AS”) materials.

Softening Agents

The composition may comprise one or more softening agents. Exemplary softening agents are organic water-soluble water softening agents, which include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates, hydroxyethyliminodiacetates, phosphonates, iminodisuccinates, polyaspartic acids, butylated hydroxytoluene (BHT), phosphonate stabilisers such as, diethylenetriaminepenta (methylene phosphonic acid and its corresponding pentasodium salt), DTP MP and DTPMA and hydroxy ethylidene diphosphonic acid (HEDP). Further exemplary water-soluble water softening agent are neutralised or partially neutralised carboxylic acids, such as citric acid, succinic acid or maleic acid, and/or a neutralised or partially neutralised polycarboxylic acid, such as a polyacrylate of Mw: 4000-8000.

It should be noted that some substances may have several functions in the formulation. For example, HEDP is a chelating agent and it helps stabilising the hydrogen peroxide in the formulation. Another example is triethanolamine, which is a polar organic solvent, but in the present application it is considered an additive and not a polar organic solvent.

In a preferred embodiment, the composition comprises:

A liquid laundry composition comprising:
between 1 wt. % and 15 wt. % of an oxygen-based bleach, based on the total weight of the composition;
between 0.001 wt. % and 10 wt. % of a homopolymer of 1-vinyl-2-pyrrolidone (PVP), based on the total weight of the composition;
hydroxy ethylidene diphosphonic acid (HEDP);
wherein the weight ratio of the homopolymer of 1-vinyl-2-pyrrolidone to the oxygen-based bleach is higher than 0.009:1; and
wherein the oxygen-based bleach is hydrogen peroxide.

Optical Brightener

The composition may comprise an optical brightener, preferably selected from the group comprising stilbene, benzidine, benzothiazole, benzimidazole, benzoxazole, coumarin, pyrazoline, naphtalimide, naphtoxazole, distyryl-biphenyl, benzonitrile, benzopyrazole, including their derivatives and substituted compounds, and combinations thereof. Suitable optical brighteners include 4,4′-bis(2-sulphostyryl)diphenyl, 7-Diethylamino-4-methylcoumarin, benzoxazole, 2,2′-(1,2-ethenediyl) bis[5-methyl] including their substituted compounds, 4,4′-bis (triazine-2ylamino) stilbene-2,2′-disulphonic acid, mono (azol-2-yl) stilbene and bis (azol-2yl) stilbene; styryl derivatives of benzene and biphenyl, such as 1,4-bis (styryl) benzene, 4,4′-bis (styryl) benzene, 4,4′-bis- (styryl) biphenyl, 4,4′-bis (sulphostryryl) biphenyl sodium salt; pyrazolines such as 1, 3-diphenyl-2-pyrazoline; bis (benzene-2-yl) derivatives, bis (benzoxazol-2-yl) derivatives and bis (benzimidazol-2-yl) derivatives; 2- (benzofuran-2-yl) benzimidazole; coumarins such as 4-methyl-7-hydroxy-coumarin or 4-methyl-7-diethylaminocoumarin; carbostyrils; naphthalimides; dibenzothiophene5,5-dioxide; pyrene; or pyridotriazole derivatives and combinations thereof.

When an optical brightener is present, the composition may comprise between 0.001 wt. % and 1 wt. % of at least one optical brightener, based on the total weight of the composition, preferably between 0.01 wt. % and 0.5 wt. %, more preferably between 0.05 wt. % and 0.25 wt. %.

pH Modifier

The compositions according to the invention may also comprise a pH modifier, i.e. a source of acidity or a source of alkalinity, to obtain the desired pH, on dissolution. A source of acidity may suitably be any suitable acidic compound for example a polycarboxylic acid. For example, a source of alkalinity may be a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity. Materials commonly used as a source of alkalinity are NaOH (sodium hydroxide), and Tri- Di- or Monoethanolamine; while sulfuric acid is commonly used as a source of acidity. Conventional amounts of the alkalinity or acidity source may be used.

For example, the laundry compositions according to the invention may comprise between 0.05 wt. % and 10 wt. % of a pH modifier, for example between 0.1 wt. % and 5 wt. %, based on the total weight of the formulation.

The pH of the laundry composition is, for example, between 2.5 and 6.5, preferably between 3 and 6, more preferably between 4 and 5.

The composition according to the invention is liquid. It should be understood that a liquid, as used in the present disclosure, includes not only a conventional liquid, but also emulsions, gels, suspensions, viscous liquids; which are materials that free flow when a force is applied.

The liquid composition may have a viscosity measured at 20° C. and 10 rpm of between 50 mPa·s and 50 000 mPa·s, preferably between 100 mPa·s and 10 000 mPa·s, more preferably between 250 mPa·s and 5 000 mPa·s, even more preferably between 500 mPa·s and 2500 mPa·s; for example between 750 mPa·s and 2500 mPa·s.

Therefore, the term liquid as used in the present disclosure does not encompass self-standing gels, which are considered solids instead.

In an embodiment the composition is a laundry additive composition.

The composition may include one or more additional ingredients selected from the group consisting of chelating agents, organic solvents, anti-fading agents, anti-bacterial agents, preservatives, fabric softeners, anti-static agents, fragrances, odor absorbing components, thickeners, and dyes.

In a second aspect, the invention relates to a method of washing a garment, comprising:
washing a garment with the laundry composition according to the first aspect of the invention; or
washing a garment with a mixture comprising a laundry detergent composition and the laundry composition according to the first aspect of the invention; or
adding a laundry composition according to the first aspect of the invention to a bucket with water and soaking for a predetermined length of time; or
   a) pre-treating the garment with the laundry composition according to the first aspect of the invention; and
   b) washing the pre-treated garment of step a) with the laundry composition according to the first aspect of the invention, or a laundry detergent composition, or with a mixture comprising a laundry detergent composition and the laundry composition according to the first aspect of the invention.

The garment may be made of a wide range of materials, such as cotton, linen, and synthetic materials.

A garment may be washed by adding certain amount; e.g. 100 mL, of the composition according to the first aspect of the invention to a washing machine and washing the garment following a regular cycle of said machine.

In a preferred embodiment, a garment with a mixture comprising a laundry detergent composition and between 10 mL and 500 mL of the laundry composition according to the first aspect, preferably between 20 mL and 250 mL, more preferably between 50 mL and 200 mL, even more preferably between 80 mL and 150 mL. This mixture may be added to a washing machine and the garment may be then washed following a regular cycle of said machine. The proportion in weight of regular detergent composition to the laundry composition according to the invention in the mixture may be (weight of detergent composition:weight of composition according to the invention) at least 1:1, preferably at least 1:1.5, more preferably at least 1:2, even more preferably at least 1:2.5. In other words, the amount of the composition according to the invention in the mixture may be the same or higher than the amount of the detergent composition.

A garment may be also washed by firstly pre-treating the garment with the composition according to the first aspect of the invention and then washing the pre-treated garment using a regular cycle of a washing machine to which, the composition according to the invention, or a regular laundry detergent composition or a mixture comprising a laundry detergent composition and the laundry composition according to the invention has been added. Said pre-treatment comprises for example applying an effective amount of the composition according to the first aspect to a stain on the garment, allowing the omposition to act for certain amount of time, for example 1 to 45 minutes, preferably 10 minutes, and rubbing it against itself.

In a third aspect, the invention relates to a use of the laundry composition according to the first aspect of the invention for the removal of stains from a garment and preferably for the reduction or inhibition of dye transfer from a garment.

In an embodiment, the stains comprise a polyphenolic compound, preferably the stains comprise turmeric and/or curry stains.

The garment may be made of cotton, synthetic materials or a combination thereof.

In a further aspect, the invention relates to the use of the composition according to the first aspect of the invention for the reduction or elimination of bacteria, germs, viruses and/or fungi from a garment.

The foregoing aspects may be freely combined with any of the foregoing aspects disclosed herein.

The invention will be further described, by way of example, with the reference to the following non-limiting embodiments.

### Examples

Formulations

Table 1 shows:
comparative compositions (compositions A and B) in which the weight ratio PVP:oxygen-based bleach is 0.009:1 or lower, and
a composition according to the invention (composition 1), in which the weight ratio PVP:oxygen-based bleach is 0.012:1.

The compositions were prepared by mixing the different ingredients to obtain a liquid composition with a pH of between 4 and 5, for example, 4.3; and a viscosity of between 1500-2000 mPa·s measured at 20° C. using a viscosimeter Brookfield RV, spindle S27, at 10 rpm.

TABLE 1
Laundry compositions

| | Composition | | |
|---|---|---|---|
| Ingredient | A | B | 1 |
| Sodium hydroxide | 0.44 | 0.44 | 0.44 |
| Anionic surfactant | 3.00 | 3.00 | 3.00 |
| Non-ionic surfactant | 10.75 | 10.75 | 10.75 |
| HEDP | 0.20 | 0.20 | 0.20 |
| Hydrogen peroxide | 10.00 | 10.50 | 10.50 |
| BHT | 0.03 | 0.03 | 0.03 |
| Fragrance | 0.20 | 0.15 | 0.15 |
| Dye | 0.0008 | 0.0008 | 0.0008 |
| PVP | 0.09 | 0.09 | 0.13 |
| Water | q.s. | q.s. | q.s. |
| PVP:Hydrogen peroxide | 0.009:1 | 0.0086:1 | 0.0123:1 |

In Table 1:
Non-ionic surfactant: ethoxylated alcohols with an ethoxylation degree between 2 and 8.
Anionic surfactant: Alkyl benzene sulphonic acid.
PVP: the homopolymer of 1-vinyl-2-pyrrolidone with a molecular weight of 40 000 g/mol.

Performance Tests

Stain Removal—Laundry Washing Machine

The stain removal performance of different detergent systems was tested using standard soils.

Washing Conditions

The standard soils were washed at 30° C. using water with a hardness of 28° f and one of the detergent systems shown in Table 2 in a laundry washing machine with the following specifications:
Washing machine: Miele W3164.
Wash cycle: cotton, water in main wash: 16 L, time of main wash: 70 min.
Load: 3.5 Kg of clean, white laundry

After washing, the test swathes were dried at room temperature, i.e. about 20° C., and ironed with a domestic iron.

Table 2 shows the different detergent systems that were added to the washing machine.

TABLE 2
Detergent systems

| Detergent system | Components |
|---|---|
| Com. Det. | 35 mL of a commercial detergent |
| Ds. A | 35 mL of a commercial detergent + |
| | 100 mL of Composition A |
| Ds. B | 35 mL of a commercial detergent + |
| | 100 mL of Composition B |
| Ds. 1 | 35 mL of a commercial detergent + |
| | 100 ml of Composition 1 |

In table 2, the commercial detergent is Ariel Original compact as sold in the UK.

Stain Removal

Stain removal was determined using a Datacolor 650 spectrophotometer and by measuring the Y-value of the standard soil after washing. A higher Y-value represents a better stain removal.

TABLE 3
Removal of enzymatic, bleachable and greasy stains.

| | | | Y-values | | |
|---|---|---|---|---|---|
| | | | Com. | | |
| | Standard soil | Description | Det. | Ds. A | Ds. 1 |
| Enzymatic | 033KC | Chocolate Bar | 84.75 | 86.84 | 88.64 |
| | C-S-27 | potato starch/colorant | 73.84 | 74.28 | 74.70 |
| | C-S-406 | Balsamic Dressing | 66.74 | 70.54 | 73.51 |
| | W-10Z | chocolate | 74.59 | 77.51 | 76.98 |
| | WE5DASBKC | sheep blood | 53.30 | 64.53 | 68.67 |
| | | Average | 70.64 | 74.74 | 76.50 |
| Bleachable | C-S-15 | blueberry juice | 49.97 | 54.27 | 54.97 |
| | W-10SG | spaghetti sauce | 63.59 | 62.00 | 61.85 |
| | | with meat | | | |
| | W-10U | curry | 83.52 | 84.38 | 84.95 |
| | WE5ECWKC | coffee | 64.42 | 65.82 | 67.51 |
| | WE5FSMWKC | french squeeze | 74.16 | 77.05 | 77.61 |
| | | mustard | | | |
| | WE5GMWKC | Grass/Mud | 54.36 | 50.87 | 54.30 |
| | WE5LTWKC | tea | 46.04 | 49.66 | 50.57 |
| | WE5RWWKC | Red wine | 55.94 | 60.56 | 60.37 |
| | WE5SGWKC | Grass scrubbed | 50.62 | 58.03 | 59.44 |
| | WE5TPWKC | Tomato puree | 71.28 | 72.46 | 73.41 |
| | | Average | 61.39 | 63.51 | 64.50 |
| Detergency | W-10D | skin grease/pigment | 56.06 | 59.78 | 61.57 |
| | W-10MU | make up | 72.94 | 71.70 | 74.84 |
| | W-10RM | Soot mineral oil, IEC | 34.82 | 38.18 | 41.48 |
| | W-10V | soy sauce | 88.92 | 89.48 | 89.33 |
| | WE5BBPC2 | cooked beef fat | 81.59 | 82.59 | 83.78 |
| | | (PES/cot) | | | |
| | WE5BBWKC | cooked beef fat | 82.44 | 85.96 | 87.75 |
| | | Average | 69.46 | 71.28 | 73.12 |

From table 3, it is clear that the laundry composition according to the invention, in particular in combination with a laundry detergent composition, provides stain removal, in particular, removal of stains comprising a polyphenolic compound, such as turmeric and/or curry stains.

It should be noted that stains which are normally removed using enzymes, are removed with the composition according to the invention.

Hence one or more objects of the present invention are achieved by the present which is further elucidated in the appended claims.

What is claimed is:

1. A liquid laundry composition comprising:
between 4 wt. % and 15 wt. % of hydrogen peroxide, based on the total weight of the liquid laundry composition;
between 0.001 wt. % and 10 wt. % of a homopolymer of 1-vinyl-2-pyrrolidone (PVP), based on the total weight of the liquid laundry composition; and
between 5 wt. % and 25 wt. % of one or more surfactants, based on the total weight of the liquid laundry composition,
wherein the weight ratio of the homopolymer of 1-vinyl-2-pyrrolidone to the oxygen-based bleach is higher than 0.009:1.

2. The liquid laundry composition according to claim 1, wherein the weight ratio of the homopolymer of 1-vinyl-2-pyrrolidone to the hydrogen peroxide is lower than 10:1, preferably lower than 5:1, more preferably lower than 1:1, even more preferably between 0.01:1 and 0.5:1.

3. (canceled)

4. The liquid laundry composition according to claim 1, wherein the composition comprises between 4 wt. % and 13 wt. % of hydrogen peroxide, based on the total weight of the liquid laundry composition, preferably between 4 wt. % and 12 wt. %.

5. The liquid laundry composition according to claim 1, wherein the homopolymer of 1-vinyl-2-pyrrolidone (PVP) has a molecular weight of between 10,000 g/mol and 200,000 g/mol, preferably between 20,000 g/mol and 100,000 g/mol, more preferably between 30,000 g/mol and 50,000 g/mol, even more preferably between 35,000 g/mol and 45,000 g/mol.

6. The liquid laundry composition according to claim 1, wherein the liquid laundry composition comprises between 0.005 wt. % and 5 wt. % of the homopolymer of 1-vinyl-2-pyrrolidone (PVP), based on the total weight of the liquid laundry composition, preferably between 0.01 wt. % and 2.5 wt. %, more preferably between 0.025 wt. % and 1 wt. %, even more preferably between 0.05 wt. % and 0.5 wt. %.

7. The liquid laundry composition according to claim 1, wherein the liquid laundry composition comprises between 10 wt. % and 20 wt. % of the one or more surfactants, based on the total weight of the liquid laundry composition.

8. The liquid laundry composition according to claim 7, wherein the one or more surfactants are selected from the group consisting of anionic surfactants, non-ionic surfactants, cationic surfactants, amphoteric surfactants, zwitterionic surfactants, and combinations thereof; preferably the one or more surfactants are selected from the group consisting of non-ionic surfactants, anionic surfactants and combinations thereof.

9. The liquid laundry composition according to claim 1, wherein the liquid laundry composition comprises between 10 wt. % and 90 wt. % of water, based on the total weight of the liquid laundry composition, preferably between 20 wt. % and 85 wt. %, more preferably between 50 wt. % and 80 wt. %.

10. The liquid laundry composition according to claim 1, wherein the pH at 20° C. of the liquid laundry composition is between 2.5 and 6.5, preferably between 3 and 6, more preferably between 4 and 5.

11. The liquid laundry composition according to claim 1, wherein the liquid laundry composition has a viscosity measured at 20° C. and 10 rpm of between 50 mPa·s and 50 000 mPa·s, preferably between 100 mPa·s and 10 000 mPa·s, more preferably between 250 mPa·s and 5 000 mPa·s, even more preferably between 500 mPa·s and 2500 mPa·s.

12. The liquid laundry composition according to claim 1, wherein the liquid laundry composition is a laundry additive composition.

13. A method of washing a garment, comprising:
washing a garment with the liquid laundry composition according to claim 1; or
washing a garment with a mixture comprising a laundry detergent composition and the liquid laundry composition according to claim 1; or
adding the liquid laundry composition according to claim 1 to a bucket with water and soaking for a predetermined length of time; or
a) pre-treating the garment with the liquid laundry composition according to claim 1; and
b) washing the pre-treated garment of step a) with the liquid laundry composition according to claim 1, or a laundry detergent composition, or with a mixture comprising a laundry detergent composition and the liquid laundry composition according to claim 1.

14. A method of using the laundry composition according to any claim 1 for the removal of stains from a garment, and preferably for the reduction or inhibition of dye transfer from a garment, the method comprising:
washing a garment with the liquid laundry composition according to claim 1; or
washing a garment with a mixture comprising a laundry detergent composition and the liquid laundry composition according to claim 1; or
adding the liquid laundry composition according to claim 1 to a bucket with water and soaking for a predetermined length of time; or
a) pre-treating the garment with the liquid laundry composition according to claim 1; and
b) washing the pre-treated garment of step a) with the liquid laundry composition according to claim 1, or a laundry detergent composition, or with a mixture comprising a laundry detergent composition and the liquid laundry composition according to claim 1.

15. The method of using the laundry composition according to claim 14, wherein the stains comprise a polyphenolic compound, preferably wherein the stains comprise turmeric and/or curry stains.
